(19) United States
(12) Patent Application Publication
(10) Pub. No.: US 2024/0391343 A1
(43) Pub. Date: Nov. 28, 2024

(54) APPARATUS, ARRANGEMENT, CHARGING APPARATUS, METHOD AND COMPUTER PROGRAM PRODUCT FOR CONTROLLING CHARGING EVENT

(71) Applicant: KEMPOWER OYJ, Lahti (FI)

(72) Inventors: Esko HEINO, Lahti (FI); Juho-Eemeli VEIKKOLAINEN, Lahti (FI); Juha VARKKI, Lahti (FI)

(21) Appl. No.: 18/696,514

(22) PCT Filed: Sep. 23, 2022
(86) PCT No.: PCT/FI2022/050641

§ 371 Date: Mar. 28, 2024

(30) Foreign Application Priority Data
Sep. 29, 2021 (FI) 20216007

(51) Int. Cl. B60L 53/65; B60L 53/66; B60L 53/67

(52) U.S. Cl. CPC B60L 53/65; B60L 53/66; B60L 53/67; B60L 2250/16

(57) ABSTRACT

An apparatus (1) for controlling a charging event is configured to receive data from at least two of the following types of sources: vehicle data from a vehicle (10) at a charging site (22), external data from an external source (8) and charging apparatus data detected by a charging apparatus (21). Further, the apparatus (1) is configured to determine, during the charging event, a vehicle type of the vehicle automatically on the basis of at least two of said vehicle data, said external data and said charging apparatus data.

### BACKGROUND

The disclosure relates to charging events for charging vehicles, and more particularly to an apparatus and method for controlling a charging event. The present disclosure further concerns a charging apparatus and an arrangement for controlling a charging event.

The number of electrically rechargeable vehicles, driven partly or fully by electric energy, increases heavily around the world. These vehicles require charging stations to recharge batteries of the vehicles. Besides private charging stations, usually provided at or near the home or place of business of the vehicle end user, such as the owner and/or the driver, public charging stations are needed to enable journeys exceeding the operating range of the battery of the vehicle. The increase in the number of rechargeable vehicles also increases the need for this type of public charging stations and may also cause queues to form at the charging stations.

There are a large number of different types of rechargeable vehicles available at the moment, and the number is increasing constantly to fulfil the needs of different types of end users. The charging characteristics of the vehicles and the profiles of the vehicle end users vary heavily. In spite of this, the charging stations currently treat all rechargeable vehicles more or less in a similar way.

There have been some attempts to change this. One example is identifying a rechargeable vehicle based on an RFID tag provided in the vehicle and a RFID reader provided at the charging station. RFID identification is, naturally, a reliable way to identify a vehicle, but it is in practice impossible to implement for all rechargeable vehicles, as it requires that that each and every rechargeable vehicle is provided with an RFID tag. Another example is identifying the vehicle based on a license plate on the vehicle. This, too, would provide a reasonably reliable identification, but it would require that the charging station would be at all times in connection all relevant vehicle registration databases, also the foreign ones in order to be able to identify foreign vehicles as well. A third example is a manual identification by charging station personnel. Manual identification is very time consuming and prone to human errors and requires a lot of personnel. However, wireless connections are not always reliable, especially if there are several vehicles close to each other and causing interference or if the vehicle battery is very close to being completely discharged.

A further problem with unique vehicle identifiers of different types is that identifying a unique vehicle is very close to identifying an individual end user. Thus, there might exist different types of laws and regulations relating to the protection of the privacy of the individual that need to be taken into consideration. On the other hand, some vehicle manufacturers constantly change the unique vehicle identifiers for this particular reason, or for some other reason, or use a common identifier for all the vehicles manufactured by the same manufacturer, which makes use of such unique vehicle identifiers inefficient and unreliable for charging purposes.

### BRIEF DESCRIPTION OF THE DISCLOSURE

An object of the present disclosure is to provide a new method, a new apparatus, a new arrangement and a new charging apparatus for controlling a charging event.

The object of the disclosure is achieved by a method, a apparatus, an arrangement, a charging apparatus, and a computer program product for controlling a charging event which [are] characterized by what is stated in the independent claim [s]. The preferred embodiments of the disclosure are disclosed in the dependent claims.

The disclosure is based on the idea of controlling a charging event and particularly on the idea of determining the vehicle type of the vehicle automatically during the charging event based on data received from at least two different sources. More particularly, the sources may preferably comprise at least two of vehicle data received from the vehicle, charging apparatus data detected by the charging apparatus, and external data.

An advantage of the method, apparatus and arrangement of the disclosure is that automatic identification of the vehicle type, such as the make and model, improves the efficiency of the charging event. In addition, the determined vehicle type alone or combined together with other data collected can be used to in many ways to benefit for instance the charging event, the vehicle, the driver of the vehicle and/or the charging apparatus.

### BRIEF DESCRIPTION OF THE DRAWINGS

In the following the disclosure will be described in greater detail by means of preferred embodiments with reference to the accompanying drawings, in which

FIG. 1 illustrates schematically an apparatus for controlling a charging event;

FIG. 2 illustrates schematically a vehicle on a charging site;

FIG. 3 illustrates schematically a vehicle on a charging site seen from above;

FIG. 4 illustrates schematically an arrangement for controlling a charging event;

FIG. 5 illustrates schematically a method for controlling a charging event;

FIG. 6 illustrates schematically an example of a method for controlling a charging event, and

FIG. 7 illustrates schematically an embodiment of a method for determining a vehicle type.

The figures are provided for illustrative purposes and to clarify the disclosure only. The figures are not shown to scale. For the sake of clarity, only one or some of similar features may be provided with reference signs.

### DETAILED DESCRIPTION OF THE DISCLOSURE

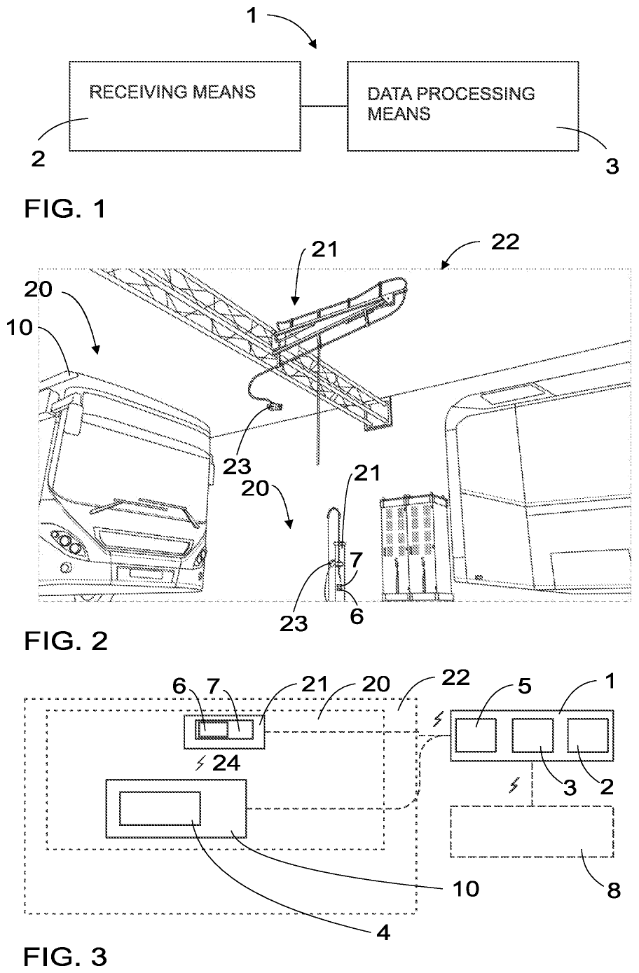

FIG. 1 illustrates schematically an apparatus 1 for controlling a charging event. Such an apparatus 1 may comprise at least receiving means 2 and data processing means 3. Different embodiments of the apparatus 1 are described in this disclosure. It is clear for a person skilled in the art that such an apparatus may comprise a plurality of other features in addition to those discussed in this description.

FIG. 2 illustrates schematically a vehicle on a charging site seen in perspective. FIG. 2 is provided to illustrate terms and concepts referred to in this description. It is clear for a person skilled in the art that FIG. 2 only illustrates an embodiment of a charging site and that the apparatuses, arrangements, methods, vehicles and other features disclosed in this description and accompanying drawings may be used in connection with many different types of charging sites and set-ups as well. FIG. 3 illustrates schematically a vehicle on a charging site seen from above.

In this disclosure, charging event refers to an event for charging a rechargeable vehicle 10, also called the vehicle, preferably with electric energy. In other words, the charging event preferably comprises an electronic charging event and the rechargeable vehicle, or vehicle, preferably comprises an electrically rechargeable vehicle. In FIG. 2, the vehicle 10 is a bus or similar, but depending on the embodiment, the vehicle 10 may comprise any type of a vehicle, such as a car or a truck.

Charging of the vehicle 10 may comprise wired and/or wireless charging. Charging a vehicle, or more particularly energy storing means 4 of the vehicle, such as a battery, may also be called recharging. The charging event starts when the vehicle enters a charging position 20. In this disclosure, a charging position 20 refers to a limited area in the close proximity of a charging apparatus 21, where charging of the vehicle 10 can take place. In other words, the charging position 20 is defined by the position of the charging apparatus 21 and the area within which a vehicle can be connected to the charging apparatus 21 for charging the vehicle, and more particularly for charging energy storing means 4, such as at least one battery of the vehicle 10. A charging site 22 may comprise one or more charging apparatuses 21 and charging positions 20.

According to an embodiment, the charging event starts, when the vehicle 10 is stopped within the charging position 20. According to another embodiment, the charging event starts when the vehicle 10 is connected to the charging apparatus 21 either in a wired manner via a charging connector 23, such as in the embodiment of FIG. 2 illustrating two embodiments of charging apparatuses 21, or via a wireless connection 24, such as in the embodiment of FIG. 3. According to an embodiment, the vehicle 10 may be connected to the apparatus 1 and/or the charging apparatus 21 via both a charging connector 23 and a wireless connection 24. In such embodiments, one or both of the charging connector 23 and the wireless connection 24 may be configured to charge electric energy to the vehicle 10. Similarly, in such embodiments, one or both of the charging connector 23 and the wireless connection 24 may be configured to send data to and/or receive data from the vehicle 10.

According to an embodiment, the charging event ends, when the vehicle is disconnected from the charging apparatus 21. According to another embodiment, the charging event ends, when the vehicle leaves the charging position 20. The expression “during a charging event” refers to the period of time between a charging event starting and the charging event ending.

A charging apparatus 21 refers to a machine connectable to one or more vehicles 10 for charging the vehicle(s). According to an embodiment, a charging apparatus 21 may comprise a charging station or a combination of two or more charging stations.

An apparatus 1 for controlling a charging event may be configured to receive, during the charging event, vehicle data from a vehicle 10 at a charging site 22. In other words, the apparatus 1 may receive vehicle data from a vehicle 10 provided at the charging site 22 at the time when the vehicle data is received. According to an embodiment, the apparatus 1 may, more particularly, be configured to receive vehicle data from a vehicle 10 provided within a charging position 20. According to an embodiment, data from the vehicle 10 may be received by receiving means 2 of the apparatus. The vehicle data does not need to concern, in context with this description and accompanying drawings, solely data about the vehicle itself, but it refers to all data received by the apparatus 1 from the vehicle 10 in connection with and/or during the charging event.

The apparatus 1 may further be configured to receive external data from an external data source 8. According to an embodiment, external data may be received by receiving means 2 of the apparatus. According to an embodiment, at least some of the external data may be received in the apparatus 1 during the charging event. According to an embodiment, at least some of the external data may be received in the apparatus 1 before the charging event and retrieved during the charging event. According to an embodiment, at least some of the external data may be received in the apparatus 1 before the charging event, stored in a memory 5 of the apparatus 1, and retrieved from the memory 5 during the charging event.

The apparatus 1 may further be configured to receive charging apparatus data detected by a charging apparatus 21. According to an embodiment, charging apparatus data may be received by receiving means 2 of the apparatus. Similarly to vehicle data and external data, the expression “charging apparatus data” refers to the source of the data and may, and typically does, comprise data detected but not related to the charging apparatus itself. According to an embodiment, at least some of the charging apparatus data may be detected by the charging apparatus 21 during the charging event. According to an embodiment, at least some of the charging apparatus data may be detected by the charging apparatus 21 before the charging event and retrieved during the charging event. According to an embodiment, at least some of the charging apparatus data may be detected by the charging apparatus 21 before the charging event, stored in a memory of the charging apparatus 21, and retrieved from the memory during the charging event. Depending on the embodiment, the memory of the charging apparatus 21 may comprise the memory 5 of the apparatus 1 or a separate charging apparatus memory 6.

The apparatus 1 may, thus, be configured to receive data from at least two, preferably three, of the following types of sources: vehicle data from the vehicle, external data and charging apparatus data detected by the charging apparatus 21. According to an embodiment, vehicle data, external data and/or the charging apparatus data is received during the charging event. According to an embodiment, at least vehicle data is received during the charging event. According to an embodiment, vehicle data, external data and/or the charging apparatus data may be received at the start of the charging event, such as when the vehicle 10 stops within the charging position 20 or when the vehicle is connected to the charging apparatus 21. According to other embodiments, at least some of the vehicle data, the external data and/or the charging apparatus data may be received during charging or at the end of the charging event, such as when the vehicle 10 is disconnected from the charging apparatus 21 and leaved the charging position 20.

The apparatus 1 may further be configured to determine, during the charging event, a vehicle type automatically on the basis of at least two of vehicle data, external data and charging apparatus data. The vehicle type may comprise at least one of the following: a make of the vehicle 10, a model of the vehicle 10, or a capacity of the energy storing means 4 of the vehicle. The capacity of the energy storing means 4 refers to the maximum or nominal amount of energy the energy storing means of the vehicle 10, such as the at least one battery of the vehicle, is capable of storing. The capacity of the energy storing means of electrically rechargeable vehicles is often described in kWh.

Determining the vehicle type automatically refers to the vehicle type being determined without human involvement, in other words without any manual input from the vehicle driver, charging site personnel or any other person. According to further embodiments, the apparatus 1 may be configured to determine the vehicle type automatically on the basis of data received from three of these different sources. An advantage of such embodiments is that the more sources data is received from, the more reliable the determination of the vehicle type is and the more additional data may be received to enable further analysis and further uses for the data in connection with the charging event. Such data may also be collected to be further analysed and used for data analysis, machine learning and artificial intelligence to further develop future charging events and services related to the charging events or the vehicles being charged.

According to an embodiment, the vehicle type may comprise at least one of the following: a make of the vehicle, a model of the vehicle, or a capacity of the energy storing means 4 of the vehicle. According to an embodiment, the vehicle type comprises at least a make of the vehicle and a model of the vehicle. According to an embodiment, the vehicle type comprises a make of the vehicle, a model of the vehicle, and a capacity of the energy storing means 4 of the vehicle. According to an embodiment, the apparatus 1 may be configured to determine the vehicle type at the charging site 22. According to an embodiment, the vehicle type may be determined by processing means 3 of the apparatus 1.

According to an embodiment, the receiving means 2 may comprise a receiver for receiving data wirelessly or via a wired connection provided in the apparatus 1. Such receivers are generally known in the art and are not described here in more detail.

According to an embodiment, the vehicle data is configured to be received from the vehicle wirelessly, via a wired connection and/or via a charging connection. There may also be different types of data transfers involved in different embodiments. For instance in embodiments where the apparatus 1 is a unit separate from the charging apparatus 21, vehicle data may be transferred from the vehicle 10 to the charging apparatus 21 via the charging connection and from the charging apparatus 21 to the apparatus 1 via a wired or wireless connection. A charging connection refers to the equipment and the actual connection between the vehicle 10 and the charging apparatus 21, which are used to charge energy, preferably electric energy, to energy storing means 4 of the vehicle 10.

According to an embodiment, vehicle data may comprise at least one of the following: data related to a charge level of energy storing means 4 of the vehicle 10, vehicle make, vehicle model, capacity of the energy storing means of the vehicle, vehicle identification, desired amount of energy for the vehicle, a maximum current indicated by the vehicle, a voltage indicated by the vehicle, and a maximum power limit indicated by the vehicle. According to an embodiment, data related to a charge level of energy storing means 4, such as at least one battery, of the vehicle 10 may comprise at least one of the following: battery charge level, battery voltage level, battery power level, battery current level, target battery current, target battery voltage, a time estimate to fully charge the battery, and time estimate to reach 80% battery charge. According to an embodiment, instead of or in addition to being received from the vehicle, one or more of the listed types of data may be determined by the apparatus 1, such as by the data processing means 3, and/or by the charging apparatus 21.

According to an embodiment, the data processing means 3 may comprise a programmable logic and/or programmable microprocessor, for example.

According to an embodiment, the charging apparatus data is detected by the charging apparatus using at least one detector provided in connection with the apparatus. According to an embodiment, such a detector may comprise for instance a receiver detecting a wireless network detectable at the apparatus 1 and/or at the charging apparatus 21. The receiver may comprise at least a part of the receiving means 2 of the apparatus 1, or a separate receiver provided in connection with the charging apparatus. Such a wireless network may be for instance a short-range or medium-range wireless network using a short-range or medium-range communication mode, such as Wi-Fi, Zigbee, Bluetooth, or infrared. Data related to such wireless networks may comprise data indicating or relating to a vehicle type of the vehicle. According to an embodiment, the detector may comprise a sensor or meter, such as a temperature sensor or thermometer. According to an embodiment, charging apparatus data may be detected by a plurality of detectors, which may be of different types.

According to an embodiment, the charging apparatus data comprises at least one of the following: temperature at the charging site, names of the detectable wireless networks, strength of the detectable wireless networks, coverage of the detectable wireless networks, the manufacturers of the detectable wireless networks, analysis information about receivers of detectable wireless networks, and analysis information about packages sent by the detectable wireless networks.

According to an embodiment, in addition to or instead of what is disclosed above, namely vehicle data, external data and charging apparatus data, the apparatus 1 may be further configured to receive additional data from the vehicle or to detect additional data by the charging apparatus. The additional data may comprise at least one of the following: a number of messages sent by the vehicle, an attenuation level of messages sent by the vehicle, a CP voltage (Control Pilot), delays related to vehicle communication, such as a start delay, end delay and delays between messages, a size of messages sent by the vehicle, a runId generated by the vehicle for the charging event, a TCP window size, a communication encryption type, a value controlling the number of messages sent, such as NumSounds and/or MaxEntriesSAScheduleTuple, a vehicle-reported HopLimit, i.e. how many times an IPV6 packet can be forwarded until it is rejected, a sender's Mac address, an ipv6 address and port, a communication protocol used by the vehicle, a charging protocol used by the vehicle, a vehicle type of the vehicle charging connector, a maximum current and a maximum power limit indicated by the vehicle, a vehicle identification indicated by the vehicle, service messages sent by the vehicle, a battery capacity indicated by the vehicle, a battery capacity calculated by the charging apparatus, indication whether the energy of the vehicle is used for heating or cooling an inside space of the vehicle, a temperature control value of the battery, a charging profile indicated by the vehicle, a desired charging start time indicated by the vehicle, a field indicating a mainly fully charged vehicle, a charge truth variable, such as ChargeProgress and/or ReadyToChargeState, and a content of a welding check for the vehicle asking to check a state of the charging contactors. As an example, regarding delays related to vehicle communication, time of delay can be used to interpret the time at which the vehicle sends any messages or performs any actions that delay sending the message.

According to an embodiment, the external data may comprise data collected by the apparatus 1 from external sources, for instance external information systems. The external data may comprise at least one of the following: weather information related to a location, road weather data, electricity price data, data related to the determined vehicle type, statistical data related to the determined vehicle model, traffic data, such as nearby area congestion information, and data related to nearby charging stations, such as occupancy rate, queuing situation and information about the operation of the nearby charging stations.

In this disclosure, external information systems may comprise for instance computers responding to queries and returning information via communication networks. Such computers may comprise for instance server computers connected to internet or other communication networks. Server computers may be open to public, they may be connected to private networks or they may be combinations of these alternatives. Some or all of the data and information on the computers may be open to public and/or at least some of the data and information may require an authentication.

According to an embodiment, the vehicle 10 is an electric vehicle powered at least partly by electric energy. Thus, the charging event comprises charging electric energy to energy storing means 4, typically a battery, of the vehicle 10. Different types of batteries for electric vehicles are generally known in the art and the type of the electric energy storing means is not relevant for the apparatus and method described. Therefore, the energy storing means 4 are not described here in more detail.

According to an embodiment, the apparatus 1 is further configured to optimize, on the basis of at least the vehicle type data determined during the charging event, the charging event for at least one of the following: the vehicle 10 and a charging apparatus 21. In other words, controlling a charging event may comprise optimizing the charging event for the vehicle 10, the charging apparatus 21 or both of them. According to an embodiment, the apparatus 1 is configured to optimize the charging event for the vehicle 10 by providing to the vehicle a maximum charging power the vehicle is capable to receive.

According to an embodiment, the apparatus 1 is configured, instead of or in addition to the vehicle 10, to optimize the charging event for the charging apparatus 21 by selecting the charging power for the vehicle in such a manner that the charging power is balanced between the vehicles simultaneously connected to the charging apparatus. According to an embodiment, where the charging event is optimized at least for the charging apparatus 21, the charging power is balanced between vehicles simultaneously connected to the charging apparatus 21 according to a predetermined criteria or strategy.

An apparatus according to claim 1, wherein the further information or further services comprise at least one of the following: information about a condition of the vehicle, information about a condition of a battery of the vehicle, information about a condition of the vehicle or the battery compared to data collected from other vehicles of the same vehicle type, targeted services and a targeted advertisement.

According to an embodiment, the apparatus 1 may comprise the charging apparatus 21, a control unit 7 of a charging apparatus 21 or an apparatus connected to the charging apparatus 21. According to an embodiment, wherein the apparatus 1 comprises the charging apparatus 21 or the control unit 7 of the charging apparatus 21, the apparatus 1 may be provided in connection with the charging apparatus 21 and not remotely to the charging apparatus 21, as illustrated in FIG. 3. According to an embodiment, the control unit 7 may comprise the data processing means 3.

According to an embodiment, the apparatus 1 may be provided as a part of a charging apparatus or directly attached to the charging apparatus. According to another embodiment, the apparatus 1 may be provided separately from the charging apparatus, but within the charging site. In such embodiments, one such apparatus 1 may be configured to serve one, two or more charging apparatuses. According to a further embodiment, the apparatus 1 or a part of it, such as the processing means 3, may be provided remotely from the charging site.

According to an embodiment, a charging apparatus 21 may comprise an apparatus 1 according to an embodiment or a combination of embodiments described in this disclosure.

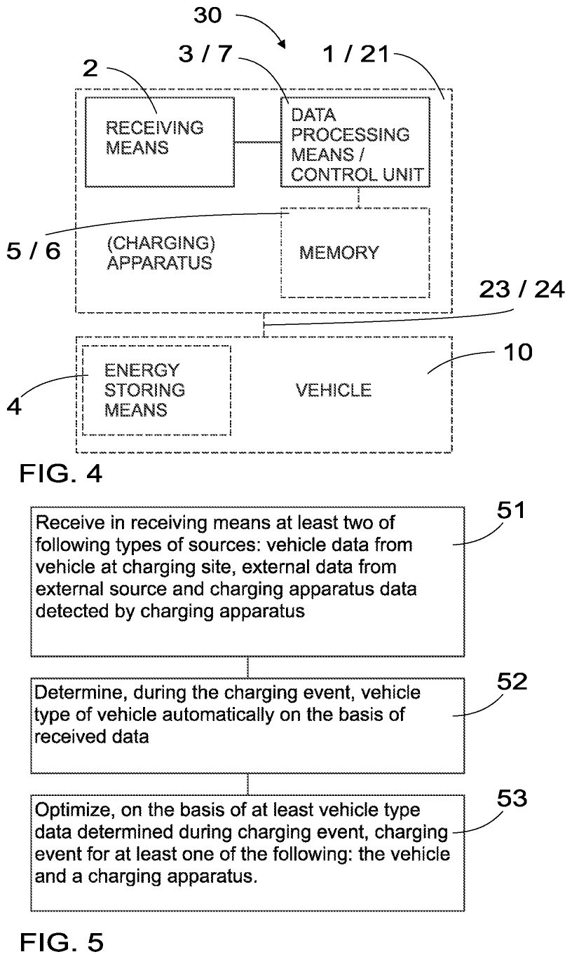

FIG. 4 illustrates schematically an arrangement 30 for controlling a charging event. According to an embodiment, an arrangement 30 for controlling a charging event may comprise receiving means 2 and data processing means 3. The receiving means 2 may be configured to receive data from at least two of the following types of sources: vehicle data from a vehicle at a charging site, external data from an external source and charging apparatus data detected by a charging apparatus. The data processing means 3 may be configured to determine, during the charging event, a vehicle type of the vehicle automatically on the basis of at least two of the vehicle data, the external data and the charging apparatus data. According to an embodiment, the data processing means 3 may be configured to determine the vehicle type of the vehicle at the charging site. The arrangement may comprise an apparatus 1 according to an embodiment or a combination of embodiments disclosed in this description and accompanying drawings. The apparatus 1 may comprise the receiving means 2 and/or the data processing means.

According to an embodiment, the arrangement 30 further comprises the memory 5 of the apparatus 1, which may comprise the charging apparatus memory 6 or a separate memory. According to an embodiment, the arrangement 30 may further comprise the charging connector 23 and/or the wireless connection 24 for providing energy, preferably electric energy, to and/or exchanging data with the vehicle. The exchanging data with the vehicle may comprise receiving data from and/or sending data to the vehicle 10. According to an embodiment, the arrangement 30 may further comprise the vehicle 10 and the energy storing means 4 of the vehicle, whereby energy may be provided by the charging apparatus 21 to the energy storing means 4, wherein the charging of the vehicle 10 is controlled according to an embodiment or a combination of embodiments disclosed in this description and accompanying drawings.

FIG. 5 illustrates schematically a method for controlling a charging event. According to the method of FIG. 5, the method comprises the steps of receiving 51 in receiving means at least two of the following types of sources: vehicle data from a vehicle at a charging site, external data from an external source and charging apparatus data detected by a charging apparatus; and determining 52, during the charging event, a vehicle type of the vehicle automatically on the basis of the received data. According to an embodiment, the method may further comprise a step of optimizing 53, on the basis of at least the vehicle type data determined during the charging event, the charging event for at least one of the following: the vehicle and a charging apparatus. According to an embodiment, the vehicle type of the vehicle may be determined automatically at the charging site. According to an embodiment, the vehicle type comprises at least one of the following: a make of the vehicle, a model of the vehicle, or a capacity of the energy storing means of the vehicle.

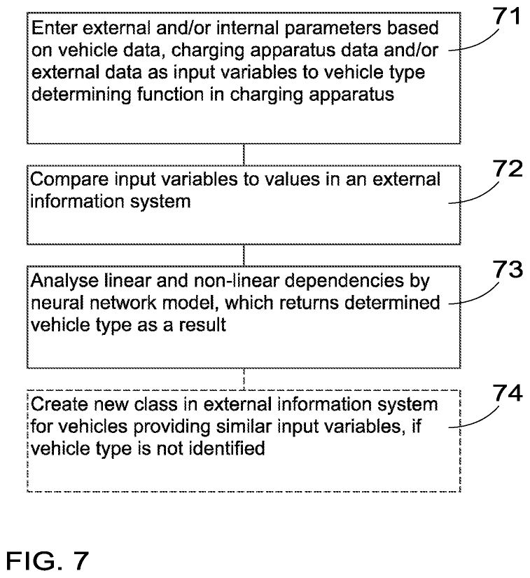

According to an embodiment, when the apparatus 1 has received vehicle data, charging apparatus data and/or external data, preferably two and most preferably three of these data types, the apparatus 1 may be configured to determine the vehicle type on the basis of linear and non-linear dependencies of the received data. According to an embodiment, the apparatus 1 may be configured to use machine learning methods to determine the vehicle type of the vehicle, such as a make and a model of the vehicle and/or the capacity of the energy storing means of the vehicle, on the basis of the linear and non-linear dependencies. FIG. 7 illustrates, schematically, an embodiment of a method for determining a vehicle type.

According to an embodiment, the apparatus 1 may further be configured to, after the apparatus 1 has determined the vehicle type of the vehicle, such as the make and the model of the vehicle and/or the capacity of the energy storing means of the vehicle, retrieve from an external source and/or from the memory 5 of the apparatus a machine learning model for forecasting a charging time comprising the determined vehicle type. According to an embodiment, the apparatus 1 is further configured to input variables related to charging of a vehicle, such as voltage, current, current charge level and desired charge level, to the machine learning model. The apparatus 1 may be configured to return a forecast about the charging time by a charging time forecasting function of the apparatus on the basis of the variables input to the system and the machine learning model retrieved.

According to an embodiment, the apparatus may be further configured to select and display further information or provide further services for a driver of the vehicle, wherein the further information is based on at least one of the following: the make of the vehicle, the model of the vehicle, the capacity of the energy storing means of the vehicle, the data received from the vehicle during the charging event and/or the external data received during the charging event.

According to an embodiment, the apparatus 1 may be further configured to provide further information or further services, such as targeted information or targeted services, for a driver of the vehicle. According to an embodiment, the apparatus 1 may be configured, after determining the vehicle type of the vehicle, analyse a condition of a battery of the vehicle compared to vehicles of the same type. According to an embodiment, the condition of the battery may be analysed by comparing the ratio between the energy charged to the battery and the charge level of the battery. According to an embodiment, the apparatus may be configured to generate such condition information related to the battery and provide it for the driver of the vehicle via at least one of the following: a graphical user interface of the charging apparatus, a graphical user interface of the vehicle and a mobile device of the driver, for instance using a specific charging application software stored in the mobile device or by reading a link directing the mobile device to retrieve the information from an information source to the mobile device display. Similarly, according to other embodiments, the apparatus may be configured to generate at least one forecast, service and/or message and provide it to the driver, the forecast, service and/or message being related to an operating range of the vehicle or some other service or useful information related to the determined vehicle type.

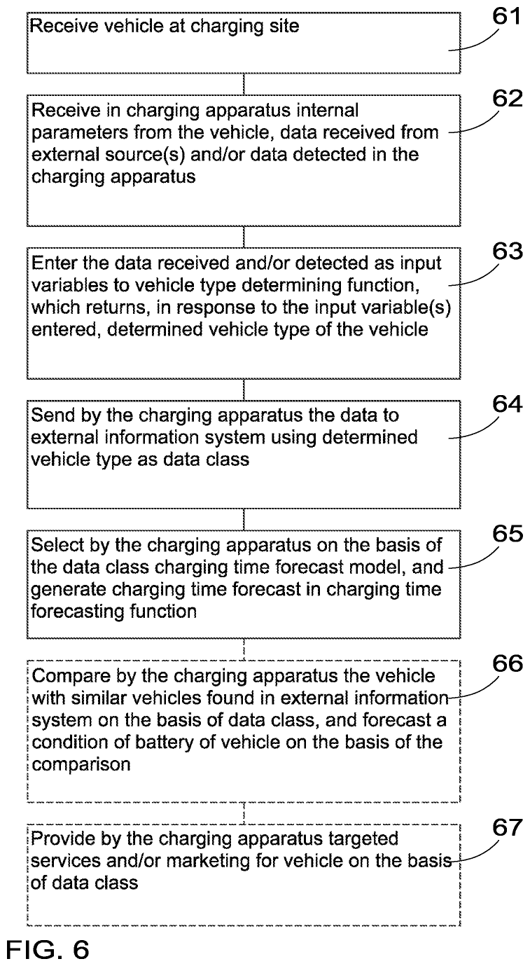

FIG. 6 illustrates schematically an example of a method for controlling a charging event. In the method of FIG. 6, the method comprises receiving 61 a vehicle 10, preferably an electric vehicle, at a charging site 22. The method further comprises receiving 62 in the charging apparatus 21 from the vehicle 10 internal parameters, in other words vehicle data, data received from external source(s), in other words external data, and/or data detected in the charging apparatus 21 parameters, in other words charging apparatus data. The data received and/or detected is then entered 63 as input variables to vehicle type determining function, which returns, in response to the input variable entered, a determined vehicle type, such as a make and a model of the vehicle and/or the capacity of the energy storing means of the vehicle. The charging apparatus 21 then sends 64 this data to an external information system using the determined vehicle type as a data class. The charging apparatus 21 then selects 65 on the basis of the data class a charging time forecast model, and a charging time forecast is generated in a charging time forecasting function. The charging apparatus 21 may further compare 66 the vehicle 10 with similar vehicles found in the external information system on the basis of the data class, and forecast a condition of a battery of the vehicle 10 on the basis of the comparison. The charging apparatus 21 may further provide 67 targeted services and/or marketing for the vehicle 10 on the basis of the data class.

FIG. 7 illustrates schematically an embodiment of a method for determining a vehicle type. In the method of FIG. 6, external and/or internal parameters based on vehicle data, charging apparatus data and/or external data are entered 71 as input variables to a vehicle type determining function in the charging apparatus 21. The input variables are then compared 72 to values in an external information system. The values used in comparison are typically provided in a form of a table comprising earlier data points related to vehicles for which the vehicle type is known for sure. This forms a pre-classification of known vehicles. Received and/or detected data is limited based on these values and a neural network model is selected, through which the data is entered.

In the method of FIG. 7, linear and non-linear dependencies are then analysed 73 by the neural network model, which then returns a determined vehicle type, or more particularly an estimated vehicle type, as a result. According to an embodiment, the linear and non-linear dependencies may comprise, for instance, non-linear dependencies between a temperature and voltage and linear dependencies between charge level and charged energy, just to name a few examples. The neural network model is taught by earlier data points to detect such dependencies in order to determine vehicle type for a vehicle, related to which certain kind of input variables are provided. According to an embodiment, teaching may comprise, especially at the beginning, so called supervised learning or similar. The model may later be updated using supervised learning, unsupervised learning on the basis of previously classified data, or some other known machine learning teaching methods or a combination of such teaching methods. According to an embodiment, several different models may be developed, and the statistically best model(s) is/are selected. Statistical metrics for comparing models may comprise for instance classification accuracy using a test group. The selection process may also comprise evaluation of effect of input variables and their mutual relations to compare different models. This kind of machine learning enables more exact results to be achieved.

If the vehicle 10 is not identified, a new class is created 74 in the external information system for vehicles providing similar input variables. If the vehicle 10 is identified, data related to the charging event is classified on the basis of a data class returned by the vehicle type determining function and entered to the external information system under the classification.

According to an embodiment, a computer program product can be in storage on a computer readable medium and capable of being executed with a processor, and the computer program product may comprise a computer readable program code. Such a computer program product can be arranged to carry out at least some of the steps of a method as presented above as the program code is being executed with a processor.

An advantage of the disclosed solutions is that the type of a rechargeable vehicle can be automatically and reliably identified at a charging station. This also enables optimizing the charging event for the vehicle, for the charging station or both. Furthermore, further information and targeted products, services and/or advertisements can be provided for the driver.

1. An apparatus for controlling a charging event, characterized in that the apparatus is configured:
to receive data from at least two of the following types of sources: vehicle data from a vehicle at a charging site, external data from an external source, and charging apparatus data detected by a charging apparatus,
to determine, during the charging event, a vehicle type of the vehicle automatically on the basis of at least two of said vehicle data, said external data, and said charging apparatus data, and
to optimize, on the basis of at least the vehicle type data determined during the charging event, the charging event for at least one of the following: the vehicle and a charging apparatus, and wherein the vehicle type comprises at least one of the following: a make of the vehicle, a model of the vehicle, or a capacity of the energy storing means of the vehicle.

2. An apparatus according to claim 1, wherein the vehicle data is configured to be received from the vehicle wirelessly, via a wired connection and/or via a charging connection, and wherein the vehicle data comprises at least one of the following: data related to a charge level of energy storing means of the vehicle, vehicle make, vehicle model, vehicle identification, capacity of the energy storing means of the vehicle, desired amount of energy for the vehicle, a maximum current indicated by the vehicle, voltage indicated by the vehicle, and a maximum power limit indicated by the vehicle.

3. An apparatus according to claim 1, wherein the charging apparatus data comprises at least one of the following: temperature at the charging site, names of the detectable wireless networks, strength of the detectable wireless networks, coverage of the detectable wireless networks, the manufacturers of the detectable wireless networks, analysis information about receivers of detectable wireless networks, and analysis information about packages sent by the detectable wireless networks.

4. An apparatus according to claim 1, wherein the external data comprises at least one of the following: weather information related to a location, road weather data, electricity price data, data related to the determined vehicle type, statistical data related to the determined vehicle type, traffic data, and data related to nearby charging stations.

5. An apparatus according to claim 1, wherein the vehicle is an electric vehicle powered at least partly by electric energy.

6. An apparatus according to claim 1, wherein the apparatus is configured to optimize the charging event for the vehicle by providing to the vehicle a maximum charging power the vehicle is capable to receive.

7. An apparatus according to claim 6, wherein the apparatus is configured to optimize the charging event for the charging apparatus by selecting the maximum charging power for the vehicle in such a manner that the maximum charging power is balanced between vehicles simultaneously connected to the charging apparatus.

8. An apparatus according to claim 7, wherein the maximum charging power is balanced between the vehicles simultaneously connected to the charging apparatus according to a predetermined criteria or strategy.

9. An apparatus according to claim 1, wherein the apparatus is further configured to select and display further information or provide further services for a driver of the vehicle, wherein the further information is based on at least one of the following: the make of the vehicle, the model of the vehicle, the capacity of the energy storing means of the vehicle, the data received from the vehicle during the charging event and/or the external data received during the charging event.

10. An apparatus according to claim 9, wherein the further information or further services comprise at least one of the following: information about a condition of the vehicle, information about a condition of a battery of the vehicle, information about a condition of the vehicle or the battery compared to data collected from other vehicles of the same vehicle type, targeted services, and a targeted advertisement.

11. An apparatus according to claim 1, wherein the apparatus comprises receiving means configured to receive said data, and data processing means configured to determine the vehicle type of the vehicle.

12. An apparatus according to claim 1, wherein the apparatus is the charging apparatus, a control unit of the charging apparatus or an apparatus connected to the charging apparatus.

13. A charging apparatus comprising an apparatus according to claim 1.

14. An arrangement for controlling a charging event, characterized in that the arrangement comprises:
receiving means configured to receive data from at least two of the following types of sources: vehicle data from a vehicle at a charging site, external data from an external source, and charging apparatus data detected by a charging apparatus, and
data processing means configured to determine, during the charging event, a vehicle type of the vehicle automatically on the basis of at least two of said vehicle data, said external data, and said charging apparatus data, and wherein the vehicle type comprises at least one of the following: a make of the vehicle, a model of the vehicle, or a capacity of the energy storing means of the vehicle.

15. An arrangement according to claim 14, wherein the arrangement comprises an apparatus 12 characterized in that the apparatus is configured:
to receive data from at least two of the following types of sources: vehicle data from a vehicle at a charging site, external data from an external source, and charging apparatus data detected by a charging apparatus,
to determine, during the charging event, a vehicle type of the vehicle automatically on the basis of at least two of said vehicle data, said external data, and said charging apparatus data, and
to optimize, on the basis of at least the vehicle type data determined during the charging event, the charging event for at least one of the following: the vehicle and a charging apparatus, and wherein the vehicle type comprises at least one of the following: a make of the vehicle, a model of the vehicle, or a capacity of the energy storing means of the vehicle.

16. A method for controlling a charging event, characterized in that the method comprises the steps of:
receiving in a receiving means data from at least two of the following types of sources: vehicle data from a vehicle at a charging site, external data from an external source, and charging apparatus data detected by a charging apparatus;
determining, during the charging event, a vehicle type of the vehicle automatically on the basis of the received data, and
optimizing, on the basis of at least the vehicle type data determined during the charging event, the charging event for at least one of the following: the vehicle and a charging apparatus, and wherein the vehicle type comprises at least one of the following: a make of the vehicle, a model of the vehicle, or a capacity of the energy storing means of the vehicle.

17. A computer program product for controlling a charging event, characterized in that the computer program product is in storage on a computer readable medium and executable with a processor, said computer program product comprising a computer readable program code, which is arranged to carry out steps of a method as set forth in claim 16 as the program code is being executed with the processor.
